(19) United States
(12) Patent Application Publication
(10) Pub. No.: US 2025/0073693 A1
(43) Pub. Date: Mar. 6, 2025

(54) NANO-CATALYSTS SYNTHESIS METHOD

(71) Applicant: National Taiwan University of Science and Technology, Taipei (TW)

(72) Inventors: Wei-Hung Chiang, Taipei (TW); Darwin Kurniawan, Taipei (TW); Ren-Jie Weng, Taipei (TW)

(21) Appl. No.: 18/426,696

(22) Filed: Jan. 30, 2024

Related U.S. Application Data
(60) Provisional application No. 63/579,159, filed on Aug. 28, 2023.

(51) Int. Cl. B01J 37/34; B01J 23/72; B01J 23/745; B01J 35/45; B01J 37/03; H05H 1/48

(52) U.S. Cl. CPC B01J 37/349; B01J 23/72; B01J 23/745; B01J 35/45; B01J 37/031; H05H 1/481

(57) ABSTRACT

A nano-catalysts synthesis method comprises steps of: using a microplasma device to perform a microplasma treatment on a precursor solution; and purifying the precursor solution after the microplasma treatment to obtain the nano-catalysts. The microplasma has a plasma size smaller than one millimeter on at least one dimension. The precursor solution comprises a precursor and a solvent. The present invention can achieve a nano-catalysts producing method at room temperature with high efficiency and yield rate through a simple and rapid process using extremely low amount of acid or alkali solvent without introducing any toxic solvents.

### FIELD OF INVENTION

The present invention relates to a method for synthesizing catalysts, particularly a nano-catalysts synthesis method.

### BACKGROUND OF THE INVENTION

Nano-catalysts have drawn more and more attention in catalysis research with its high-efficiency performance. Metal catalysts, in particular, possess one of many advantages such as high activity and stability and find widespread applications in various industrial and electrochemical catalytic reactions. Apart from their catalytic capabilities, nano-catalysts have large surface areas that can further modify the recognized molecules. They can be applied in many fields such as biomolecules, detection of heavy metal ions and anions, as well as in biomedical sensing, cancer diagnosis and treatment, environmental pollutant detection and degradation.

In particular, Single-Atom Catalysts (SACs) is one of the nano-catalysts and is known for their easy separation, excellent recyclability, and the presence of facilitating multiphase catalysts with highly uniform active centers. They offer maximum metal atom utilization efficiency and become a high profile catalysis in various fields.

The size of metal particle plays a important role in influencing the performance of SACs. SACs are composed of isolated metal atom dispersed and carried on a carrier, and the exceptionally small size of the metal particle represents a critical factor. SACs maximize the utilization efficiency of the metal atoms, which is of particular significance for loaded precious metal catalysts. Moreover, with the precise and uniform dispersion of single atoms, SACs hold substantial promise for achieving elevated levels of activity and selectivity.

However, current approaches to synthesizing nano-catalysts are rather complicated, time and energy consuming, and costly.

Hence, it is eager to have a proper or improved method for synthesizing nano-catalysts that is relatively simple, energy saving and has a short processing time to overcome or substantially ameliorate at least one or more of the deficiencies of a prior art, or to at least provide an alternative solution to the problems. More importantly, it is also lacking a method to reduce the processing cost of foamed beads for making it able to be introduced into the market of general foamed products, expanding the applications of foamed beads. It is to be understood that, if any prior art information is referred to herein, such reference does not constitute an admission that the information forms part of the common general knowledge in the art.

### SUMMARY OF THE INVENTION

In order to solve the problems or disadvantages of the conventional processing method which is complicated, time and energy consuming, and costly, the present invention introduces a nano-catalysts synthesis method comprising the following steps of:
treating a precursor solution with microplasma using a microplasma device, wherein:
the microplasma is a plasma having at least one geometric dimension measuring less than one millimeter;
the precursor solution comprises a precursor and a solvent, wherein:
the precursor comprises a first component and a second component with concentration proportion of the second component to the first component in a range of 1˜100; the first component comprises a organic polymer and the second component comprises a metal salt; and
purifying the precursor solution after microplasma treatment to obtain the nano-catalyst.

In accordance, the present invention has the following advantages:
1. The nano-catalyst synthesis method presented in the present invention requires only minimal amounts of strong acid or alkali at room temperature and eliminates the need for toxic solvents. It achieves high efficiency and productivity through a simple and rapid process. The solution-based microplasma treatment presented in the present invention boasts high efficiency and rapid reaction kinetics, making it suitable for integration into large-scale continuous operations to meet industrial-scale production requirements.
2. The nano-catalysts developed by the present invention exhibit exceptional catalytic performance and outstanding selectivity. They offer a large surface area that can further modify the recognized molecules and can be applied in various applications, such as artificial enzymes, biomolecules, detection of heavy metal ions and anions, biomedical sensing, cancer diagnosis and treatment, environmental pollutant detection and degradation. However, the existing nano-catalyst synthesis methods are complex, time-consuming, energy-intensive, and costly. The present invention introduces a novel synthesis method that is simple, rapid, cost-effective, and high-yield for nano-catalyst production.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a flowchart showing the steps in the nano-catalysts synthesis method of the present invention;

FIG. 2 is a schematic diagram of the microplasma device used in the microplasma step of the present invention;

FIGS. 3A and 3B are a Transmission electron microscopy (TEM) image of the SACs and a X-ray photoelectron spectroscopy (XPS) image proven metal existence in the SACs of the present invention, respectively;

FIGS. 4 and 5 are the test results of the 4-NP catalytic reaction of each embodiment of the present invention, respectively; and

FIGS. 6 to 8 are the test results of the catalytic reaction of POD of each embodiment of the present invention, respectively.

### DETAILED DESCRIPTION OF THE PREFERRED EMBODIMENTS

Reference will now be made in detail to the presently preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

### First Preferred Embodiment of a Method for Synthesizing Nano-Catalysts

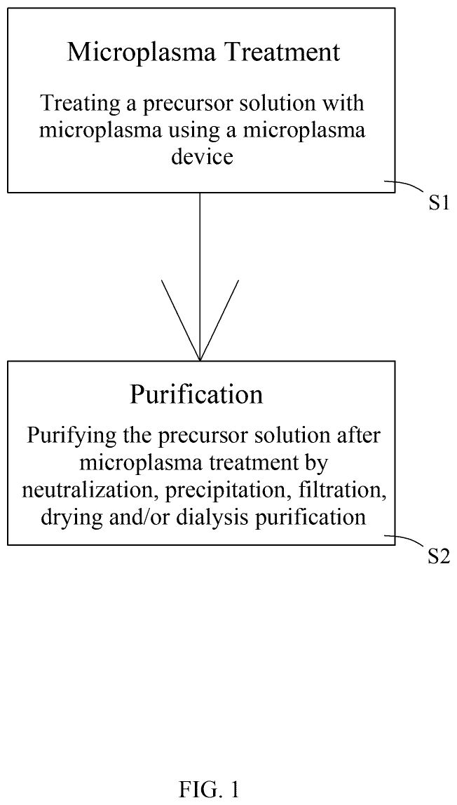

Please refer to FIG. 1, it illustrates steps of the method for synthesizing nano-catalysts of the present invention, comprising:

Step S1—Microplasma Treatment: Treating a precursor solution with microplasma using a microplasma device. The processing time of the microplasma treatment is preferred to be less than 24 hours, or preferably 1 minute to 24 hours, or even more preferably 1 minute to 300 minutes, or optimally 1 minute to 30 minutes.

Step S2—Purification: Purifying the precursor solution after microplasma treatment by neutralization, precipitation, filtration, drying and/or dialysis purification as desired. The purification step is optional based on the type of final product and are not necessary to be implemented with all listed approaches.

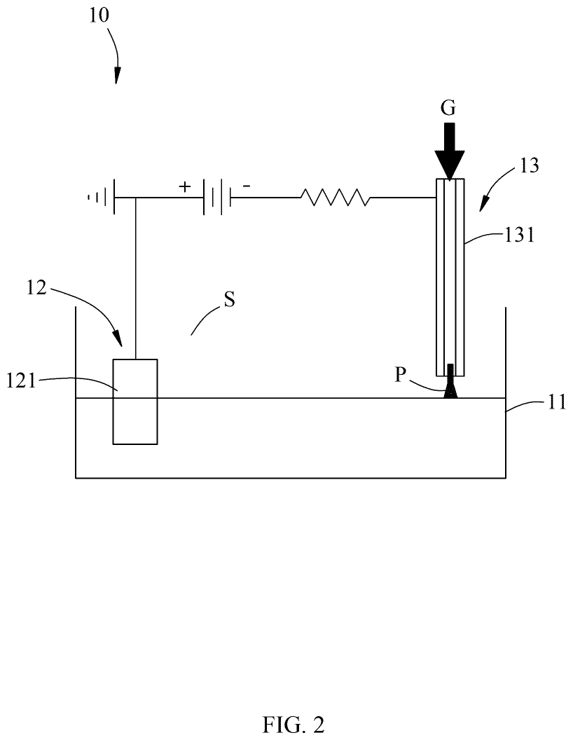

Referring to FIG. 2, where in step S1, a preferred embodiment of the microplasma device 10 comprises at least:
A microplasma tank 11 for containing the precursor solution 20;
An anode 12, which includes an electrode foil 121 at least partially immersing in the precursor solution 20, such as a platinum foil; and
A cathode 13, which is electrically connected to the anode and includes a microplasma outlet 131 set above but near a surface of the precursor solution 20, such as a capillary tube.

In this step, an inert gas G, such as Helium, Argon, or Neon is introduced into the microplasma outlet to generate the microplasma P and output to the precursor solution S.

Referring to Table 1 below, some preferred embodiments of materials, products, processing parameters that applicable to the aforementioned synthesis method in the present invention are presented.

TABLE 1

| Category | Content | |
|---|---|---|
| Precursor | Precursors | First components include organic polymer(s). |
| Solution | | Such organic polymer includes but not limited |
| | | to chitin, amino acid, plastic polymer and |
| | | derivatives thereof. |
| | | The said chitin comprises at least chitosan. |
| | | The amino acid comprises at least histidine, |
| | | methionine, or cysteine. The plastic polymer |
| | | comprises at least terephthalic acid or |
| | | polycarbonate. |
| | | Second components include metal salt(s). Such |
| | | metal salt is able to dissolve in a solvent of the |
| | | precursor solution. The metal salt is preferred |
| | | to be halide metal salt. |
| | | The metal in the metal salt comprises copper |
| | | ions (Cu²⁺), iron ions (Fe³⁺), cobalt ions (Co²⁺), |
| | | gold ions (Au²⁺), zinc ions (Zn²⁺), nickel ions |
| | | (Ni²⁺), ruthenium ions (Ru³⁺), aluminum ions |
| | | (A1³⁺) and any of two metal ions combination |
| | | thereof. |
| | Precursor | A concentration of the metal salt in the |
| | Concentration | precursor solution is preferred to be at a range |
| | | of 1 uM ~ 10M; or |
| | | A concentration of the second components and |
| | | the first components is in a proportion of |
| | | 1~100. |
| | | $( \frac{the second components}{the first components} = 1 ∼ 100 )$ |
| | Solvent | Hydrochloric (HCl), Nitric acid (HNO₃), |
| | | Methanesulfonic acid, Lactic acid, Succinic |
| | | acid, Ascorbic acid, Acetic acid, Sodium |
| | | hydroxide (NaOH), Deionized water (DI |
| | | water), Ammonia (NH₄OH) |
| | Solvent | 1 uM~10M |
| | Concentration | |

| | |
|---|---|
| Microplasma | The Plasma has a size less than one millimeter in at least one |
| Power supply | geometric dimension. |
| of the | Direct current (DC) power supply; |
| microplasma | Resistance in a range of 100~250 Kilohm; |
| | Current in a range of 1~50 mA. |
| Microplasma | Less than 24 hours each processing time. |
| processing | |
| time | |
| Nano-catalyst | Copper nano-catalyst, iron nano-catalyst, gold nano-catalyst, |
| | cobalt nano-catalyst, zinc nano-catalyst, nickel nano-catalyst, |
| | ruthenium nano-catalyst, aluminum nano-catalyst or a |
| | combination of any two of these metals. |

Referring to Table 2 below, a preferred embodiment of the nano-catalysts synthesis method in the present invention, using copper single-atom catalyst as an example. It provides details of the materials and process parameters employed in each step. It is understandably that Table 2 serves as an illustration of a preferred embodiment of the present invention and does not exclusively limit the use of these materials or process parameters. All the materials and processing parameters listed in Table 1 have been tested and have proven effective by the present invention.

TABLE 2

| Process Steps | Materials/Parameters | |
|---|---|---|
| Step S1 | Precursor | The first component is chitosan and the second |
| Microplasma | Solution | component is Copper chloride dehydrate (CuCl₂). |
| treatment | | The concentration proportion of the second |
| | | component and the first component is in a range of |
| | | $1 ∼ 100 ( \frac{Copper chloride dehydrate}{chitosan} = 1 ∼ 100 ) in this$ |
| | | preferred embodiment. |
| | Microplasma | Power Supply: DC with Resistance of 150 kilohms. |
| | | Anode (Microplasma): Inert gas Argon is introduced |
| | | into the microplasma outlet to generate microplasma |
| | | in the precursor solution. |
| | | Cathode: Platinum foil at least partially immersed in |
| | | the precursor solution. |
| | | Processing Parameters: Using 10 mL of precursor |
| | | solution, microplasma treatment at 5~20 mA for |
| | | 30~120 minutes. |
| Step S2 | Neutralization | Neutralize the solution obtained after microplasma |
| Purification | | treatment with a small amount of alkali, such as |
| | | sodium hydroxide (pH 6.9-7.5). |
| | Precipitation | Precipitate using a ketone, such as acetone (in a 2:1 |
| | | ratio or above). |
| | Filtration | Filter the precipitate |
| | | (Precipitate contains incompletely reacted copper |
| | | chloride and chitosan). |
| | Drying | Dry the filtered solution, preferably using |
| | | evaporation drying. |
| | Dialysis | Dialyze the dried product to remove residual salts. |

The chitosan in the precursor solution of the step S1 in Table 2 is preferably a weak acid-treated (HA-treated) chitosan solution.

### Second Preferred Embodiment of the Nano-Catalysts Synthesis Method

The second preferred embodiment of the nano-catalysts synthesis method in the present invention is substantially the same as the first preferred embodiment, except that in this embodiment, the microplasma treatment of step S1 can be repeated at least one more or even multiple times. Prior to each time of execution of the microplasma treatment, the corresponding precursor solution will be added, and the processing time of each microplasma treatment can be flexibly increased or decreased to increase the yield of nano-catalyst synthesis.

In this embodiment, the multiple microplasma treatment is able to produce a composite/complex metal nano-catalyst, such as a copper-iron composite nano-catalyst depending on the added precursor solution type.

### Validation Tests

Referring to Table 3 below, Table 3 shows some preferred embodiments of the present invention. Various nano-catalysts are produced by a one-step or multi-step microplasma process of the present invention. The validation tests for catalyzing of 4-Nitrophenol (4-NP) and Peroxidase (POD) are conducted for each embodiment corresponding to Table 3. It is also worth to notice that Table 3 serves as an illustration of some preferred embodiments of the present invention and does not exclusively limit the use of these materials or process parameters. All the materials and processing parameters listed in Table I have been tested and have proven effective by the present invention.

TABLE 3

| | | | | | Volume | | Volume |
|---|---|---|---|---|---|---|---|
| | | | | | concentration | Metal | concentration |
| Sample | Precursor | Conc. | | Solvent | of solvent | ion | of metal ion |
| CS-HACu | Chitosan | 62.5 | uM | Hydrochloric | 35 mM 9.6 mL | Cu²⁺ | 60 mM 0.4 mL |
| | | | | acid | | | |
| CS-HAFe | Chitosan | 62.5 | uM | Hydrochloric | 35 mM 9.6 mL | Fe²⁺ | 60 mM 0.4 mL |
| | | | | acid | | | |
| CS-NACu | Chitosan | 62.5 | uM | Nitric acid | 35 mM 9.6 mL | Cu²⁺ | 60 mM 0.4 mL |
| CS-NAFe | Chitosan | 62.5 | uM | Nitric acid | 35 mM 9.6 mL | Fe²⁺ | 60 mM 0.4 mL |
| CS-MSACu | Chitosan | 62.5 | uM | Methanesulfonic | 35 mM 9.6 mL | Cu²⁺ | 60 mM 0.4 mL |
| | | | | acid | | | |
| CS-MSAFe | Chitosan | 62.5 | uM | Methanesulfonic | 35 mM 9.6 mL | Fe²⁺ | 60 mM 0.4 mL |
| | | | | acid | | | |
| CS-LACu | Chitosan | 62.5 | uM | Lactic acid | 50 mM 9.6 mL | Cu²⁺ | 60 mM 0.4 mL |
| CS-LACo | Chitosan | 62.5 | uM | Lactic acid | 50 mM 9.6 mL | Co²⁺ | 60 mM 0.4 mL |
| CS-LAFe | Chitosan | 62.5 | uM | Lactic acid | 50 mM 9.6 mL | Fe²⁺ | 60 mM 0.4 mL |
| CS-SACu | Chitosan | 62.5 | uM | Succinic | 50 mM 9.6 mL | Cu²⁺ | 60 mM 0.4 mL |
| | | | | acid | | | |
| CS-SAFe | Chitosan | 62.5 | uM | Succinic | 50 mM 9.6 mL | Fe²⁺ | 60 mM 0.4 mL |
| | | | | acid | | | |
| CS-AsACu | Chitosan | 62.5 | uM | Ascorbic | 50 mM 9.6 mL | Cu²⁺ | 60 mM 0.4 mL |
| | | | | acid | | | |
| CS-AsAFe | Chitosan | 62.5 | uM | Ascorbic | 50 mM 9.6 mL | Fe²⁺ | 60 mM 0.4 mL |
| | | | | acid | | | |
| CS-AACu | Chitosan | 62.5 | uM | Acetic acid | 50 mM 9.6 mL | Cu²⁺ | 60 mM 0.4 mL |
| CS-AAFe | Chitosan | 62.5 | uM | Acetic acid | 50 mM 9.6 mL | Fe²⁺ | 60 mM 0.4 mL |
| PC-Cu | Polycarbonate | 0.5 | g | Sodium | 2.8M 100 mL | Cu²⁺ | 60 mM 0.4 mL |
| | | | | hydroxide | | | |
| HisCu | Histidine | 0.04M | | Sodium | 0.03M 9.6 mL | Cu²⁺ | 60 mM 0.4 mL |
| | | | | hydroxide | | | |
| HisFe | Histidine | 0.04M | | Sodium | 0.03M 9.6 mL | Fe²⁺ | 60 mM 0.4 mL |
| | | | | hydroxide | | | |
| CS- | Chitosan | 62.5 | uM | Lactic acid | 50 mM | Cu²⁺ | 60 mM 0.2 mL |
| LACuFe 60 | | | | | | Fe²⁺ | each |
| CS- | Chitosan | 62.5 | uM | Lactic acid | 50 mM | Cu²⁺ | 120 mM 0.2 mL |
| LACuFe | | | | | | Fe²⁺ | each |
| 120 | | | | | | | |
| TACu | Terephthalic | 0.1M | | Sodium | Sodium | Cu²⁺ | M 1 mL |
| | acid | | | hydroxide, | hydroxide | | |
| | | | | ammonia | 0.3M, | | |
| | | | | | ammonia3% | | |

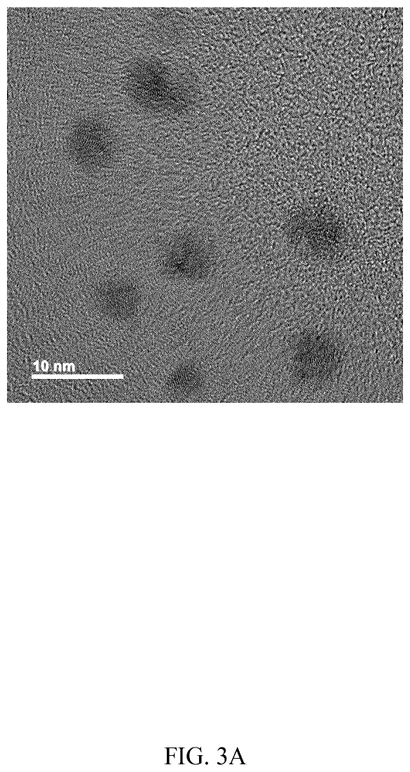

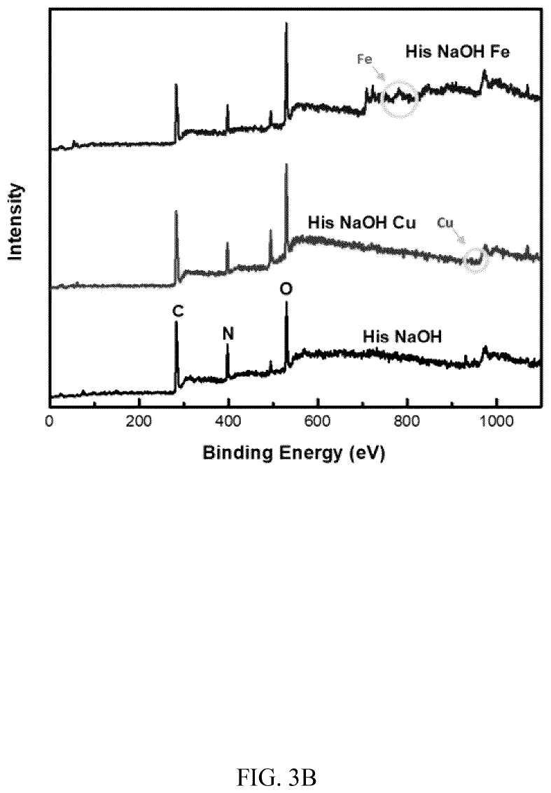

Referring to FIGS. 3A and 3B, taking the sample “HisCu”, “HisFe” of the present invention and the comparison sample “His” as example, the present invention has successfully synthesized SACs with quantum dots nano-structure. FIG. 3A is a Transmission electron microscopy (TEM) image of the SACs synthesized by the present invention. FIG. 3B further shows a X-ray photoelectron spectroscopy (XPS) image proven metal existence in the SACs. Table 4 has listed the mass percent of elements of the SACs in this embodiment.

TABLE 4

| | Mass percent of elements (%) | | | | |
|---|---|---|---|---|---|
| Sample | C | N | O | Cu | Fe |
| His | 61.68 | 12.89 | 25.43 | — | — |
| (Comparison | | | | | |
| sample) | | | | | |
| HisCu | 63.77 | 13.62 | 21.74 | 0.88 | — |
| HisFe | 56.04 | 12.02 | 27.38 | — | 4.56 |

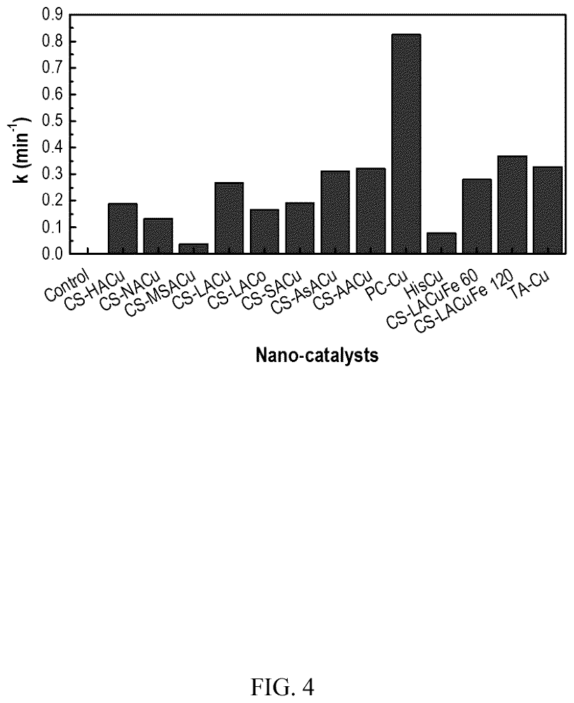

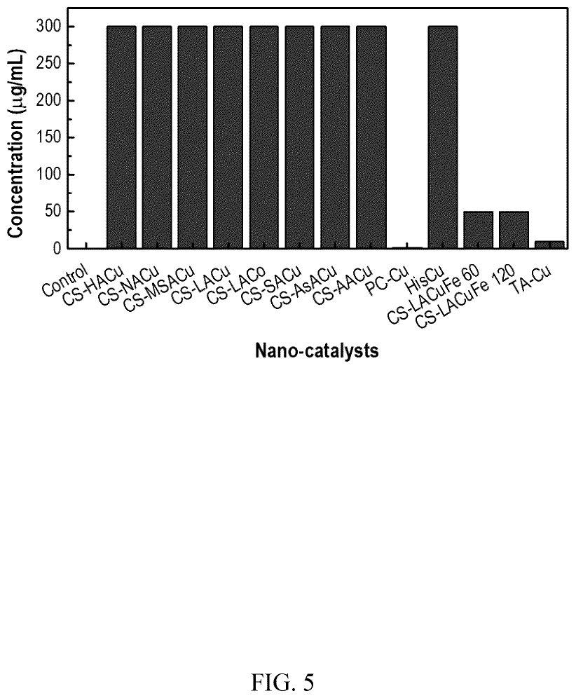

With reference to FIGS. 4 and 5, these figures show the results of the catalytic reaction of 4-NP for each embodiment of the present invention listed in Table 3. FIG. 4 shows the measured catalytic reaction constants (k) for each embodiment corresponding to Table 3 above, indicating a higher k-value resulting in a faster reaction ability or reaction rate. The embodiments of the present invention have better catalytic ability in reactions than the comparison example (Control) that does not comprise nano-catalysts.

Referring to FIG. 5, it shows the SACs concentration during the 4-NP catalytic reaction for each embodiment. The result indicates that the lower concentration of the SACs, the stronger the catalytic ability shows.

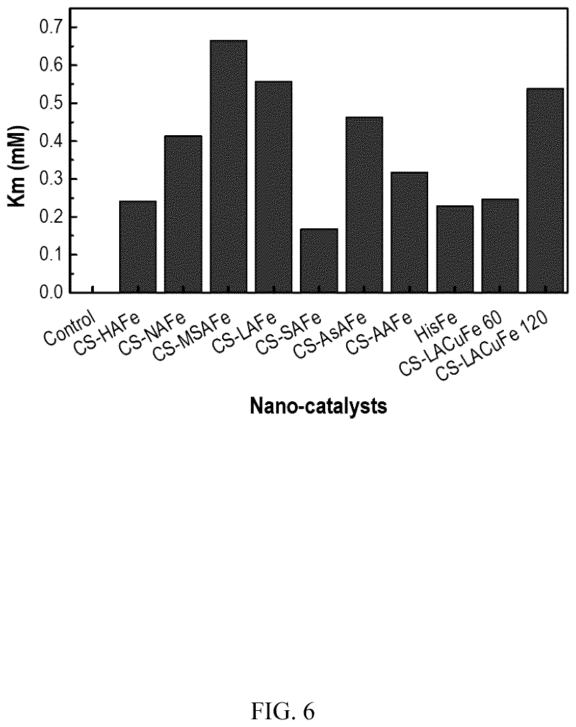

Referring to FIGS. 6 to 8, these figures are the Peroxidase (POD) catalytic validation tests for the embodiments of the present invention in Table 3. FIG. 6 has shown Km value of each embodiment indicating a lower Km value will give a better affinity for the substrate.

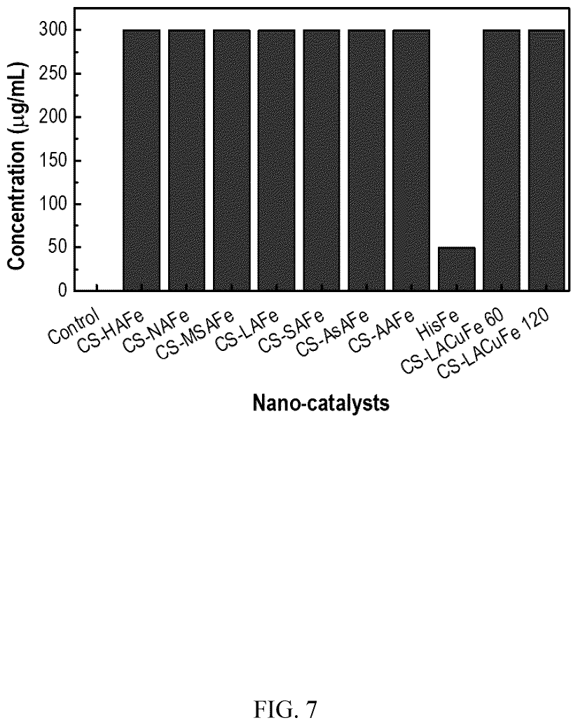

Referring to FIG. 7 for the Vmax value of each embodiment, the result shows that a higher Vmax value indicates a faster POD reaction rate.

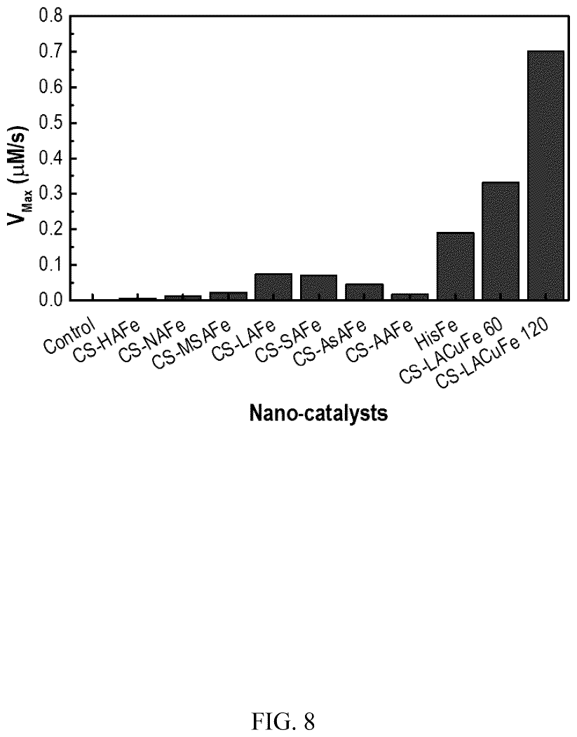

Referring to FIG. 8 for the SACs concentration during the catalytic reaction of each embodiment, the result shows that the lower of the SACs concentration, the better reaction efficiency the SACs could give. The embodiments of the present invention have better catalytic ability in reaction compared to the comparison example (Control) which does not include nano-catalysts.

Referring to Table 5 and Table 6 below, these two tables summarize the catalytic effects of the nano-catalysts of the present invention when performing 4-NP and POD catalysis.

TABLE 5

| | | 4-NP Reduction | |
|---|---|---|---|
| | | | SACs |
| | | | concentration |
| Sample | Microplasma parameters | K Value | (ug/mL) |
| CS-HACu | Two times of microplasma | 0.1879 | 300 |
| | treatment with 9.6 mA 30 min/ | | |
| | each time | | |
| CS-NACu | Two times of microplasma | 0.1337 | 300 |
| | treatment with 9.6 mA 30 min/ | | |
| | each time | | |
| CS-MSACu | Two times of microplasma | 0.0387 | 300 |
| | treatment with 9.6 mA 30 min/ | | |
| | each time | | |
| CS-LACu | Two times of microplasma | 0.2698 | 300 |
| | treatment with 9.6 mA 30 min/ | | |
| | each time | | |
| CS-SACu | Two times of microplasma | 0.1926 | 300 |
| | treatment with 9.6 mA 30 min/ | | |
| | each time | | |
| CS-AsACu | Two times of microplasma | 0.3127 | 300 |
| | treatment with 9.6 mA 30 min/ | | |
| | each time | | |
| CS-AACu | Two times of microplasma | 0.3227 | 300 |
| | treatment with 9.6 mA 30 min/ | | |
| | each time | | |
| PC-Cu | Two times of microplasma | 0.8266 | 2.2 |
| | treatment with 10 mA 30 min/ | | |
| | each time | | |
| HisCu | Two times of microplasma | 0.0798 | 300 |
| | treatment with 9.6 mA 30 min/ | | |
| | each time | | |
| CS-LACuFe | Two times of microplasma | 0.2812 | 50 |
| 60 | treatment with 9.6 mA 30 min/ | | |
| | each time | | |
| CS-LACuFe | Two times of microplasma | 0.3692 | 50 |
| 120 | treatment with 9.6 mA 30 min/ | | |
| | each time | | |
| TACu | Two times of microplasma | 0.3285 | 50 |
| | treatment with 30 min/each time | | |

TABLE 6

| | | POD | | |
|---|---|---|---|---|
| | | | | SACs |
| | | Km | Vmax | concentration |
| Sample | Microplasma parameters | (mM) | (uM/s) | (ug/mL) |
| CS-HAFe | Two times of microplasma | 0.24175 | 0.00615253 | 300 |
| | treatment with 9.6 mA 30 | | | |
| | min/each time | | | |
| CS-NAFe | Two times of microplasma | 0.41499 | 0.0108601 | 300 |
| | treatment with 9.6 mA 30 | | | |
| | min/each time | | | |
| CS-MSAFe | Two times of microplasma | 0.66385 | 0.0231268 | 300 |
| | treatment with 9.6 mA 30 | | | |
| | min/each time | | | |
| CS-LAFe | Two times of microplasma | 0.55729 | 0.074616 | 300 |
| | treatment with 9.6 mA 30 | | | |
| | min/each time | | | |
| CS-SAFe | Two times of microplasma | 0.1682 | 0.0706829 | 300 |
| | treatment with 9.6 mA 30 | | | |
| | min/each time | | | |
| CS-AsAFe | Two times of microplasma | 0.46336 | 0.0454937 | 300 |
| | treatment with 9.6 mA 30 | | | |
| | min/each time | | | |
| CS-AAFe | Two times of microplasma | 0.31762 | 0.0171679 | 50 |
| | treatment with 9.6 mA 30 | | | |
| | min/each time | | | |
| HisFe | Two times of microplasma | 0.22831 | 0.190555 | 50 |
| | treatment with 9.6 mA 30 | | | |
| | min/each time | | | |
| CS-LACuFe | Two times of microplasma | 0.247 | 0.331681 | 300 |
| 60 | treatment with 9.6 mA 30 | | | |
| | min/each time | | | |
| CS-LACuFe | Two times of microplasma | 0.53795 | 0.700288 | 300 |
| 120 | treatment with 9.6 mA 30 | | | |
| | min/each time | | | |

Tables 5 and 6 show that the method for synthesizing the nano-catalyst provided by the present invention achieves high efficiency and high yield in a simple and rapid process with minimal usage of acidic or alkaline solvents at room temperature and without the need for toxic solvents.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A nano-catalysts synthesis method comprising the steps of:
treating a precursor solution with microplasma using a microplasma device, wherein:
the microplasma is a plasma having at least one geometric dimension measuring less than one millimeter;
the precursor solution comprises a precursor and a solvent, wherein:
the precursor comprises a first component and a second component with concentration proportion of the second component to the first component in a range of 1˜100; the first component comprises a organic polymer and the second component comprises a metal salt; and
purifying the precursor solution after microplasma treatment to obtain the nano-catalyst.

2. The nano-catalysts synthesis method according to claim 1, wherein: the microplasma treatment is repeated one or more times.

3. The nano-catalysts synthesis method according to claim 2, wherein:
repeating the microplasma treatment to obtain a composite nano-catalysts.

4. The nano-catalysts synthesis method according to claim 1, wherein: each processing time of the microplasma treatment takes 1 minute to 24 hours.

5. The nano-catalysts synthesis method according to claim 2, wherein: each processing time of the microplasma treatment takes 1 minute to 24 hours.

6. The nano-catalysts synthesis method according to claim 1, wherein:
the organic polymer comprises chitin, amino acid, plastic polymer and derivatives thereof;
the solvent has concentration in a range of 1 μM˜10M and comprises hydrochloric acid, nitric acid, methanesulfonic acid, lactic acid, succinic acid, ascorbic acid, acetic acid, sodium hydroxide, deionized water, or ammonia water;
a metal in the metal salt comprises copper ions, iron ions, cobalt ions, gold ions, zinc ions, nickel ions, ruthenium ions, aluminum ions and any of two metal ions combination thereof; and
the nano-catalyst comprises copper nano-catalyst, iron nano-catalyst, gold nano-catalyst, cobalt nano-catalyst, zinc nano-catalyst, nickel nano-catalyst, ruthenium nano-catalyst, aluminum nano-catalyst or a combination of any two of these metals.

7. The nano-catalysts synthesis method according to claim 2, wherein:
the organic polymer comprises chitin, amino acid, plastic polymer and derivatives thereof;
the solvent has concentration in a range of 1 μM˜10M and comprises hydrochloric acid, nitric acid, methanesulfonic acid, lactic acid, succinic acid, ascorbic acid, acetic acid, sodium hydroxide, deionized water, or ammonia water;
a metal in the metal salt comprises copper ions, iron ions, cobalt ions, gold ions, zinc ions, nickel ions, ruthenium ions, aluminum ions and any of two metal ions combination thereof; and
the nano-catalyst comprises copper nano-catalyst, iron nano-catalyst, gold nano-catalyst, cobalt nano-catalyst, zinc nano-catalyst, nickel nano-catalyst, ruthenium nano-catalyst, aluminum nano-catalyst or a combination of any two of these metals.

8. The nano-catalysts synthesis method according to claim 6, wherein:
the chitin comprises at least chitosan;
the amino acid comprises at least histidine, methionine, or cysteine;
the plastic polymer comprises at least terephthalic acid or polycarbonate; and
the metal salt comprises halide metal salt.

9. The nano-catalysts synthesis method according to claim 7, wherein:
the chitin comprises at least chitosan;
the amino acid comprises at least histidine, methionine, or cysteine;
the plastic polymer comprises at least terephthalic acid or polycarbonate; and
the metal salt comprises halide metal salt.

10. The nano-catalysts synthesis method according to claim 1, wherein: the microplasma treatment is performed by the microplasma device comprising:
a microplasma tank for containing the precursor solution;
an anode, which includes an electrode foil; and
a cathode, which is electrically connected to the anode and includes a microplasma outlet; wherein:
an inert gas is introduced into the microplasma outlet to generate the microplasma in the precursor solution to produce the nano-catalysts.

11. The nano-catalysts synthesis method according to claim 2, wherein: the microplasma treatment is performed by the microplasma device comprising:
a microplasma tank for containing the precursor solution;
an anode, which includes an electrode foil; and
a cathode, which is electrically connected to the anode and includes a microplasma outlet; wherein:
an inert gas is introduced into the microplasma outlet to generate the microplasma in the precursor solution to produce the nano-catalysts.

12. The nano-catalysts synthesis method according to claim 3, wherein: the microplasma treatment is performed by the microplasma device comprising:
a microplasma tank for containing the precursor solution;
an anode, which includes an electrode foil; and
a cathode, which is electrically connected to the anode and includes a microplasma outlet; wherein:
an inert gas is introduced into the microplasma outlet to generate the microplasma in the precursor solution to produce the nano-catalysts.

13. The nano-catalysts synthesis method according to claim 4, wherein: the microplasma treatment is performed by the microplasma device comprising:
a microplasma tank for containing the precursor solution;
an anode, which includes an electrode foil; and
a cathode, which is electrically connected to the anode and includes a microplasma outlet; wherein:
an inert gas is introduced into the microplasma outlet to generate the microplasma in the precursor solution to produce the nano-catalysts.

14. The nano-catalysts synthesis method according to claim 5, wherein: the microplasma treatment is performed by the microplasma device comprising:
a microplasma tank for containing the precursor solution;
an anode, which includes an electrode foil; and
a cathode, which is electrically connected to the anode and includes a microplasma outlet; wherein:
an inert gas is introduced into the microplasma outlet to generate the microplasma in the precursor solution to produce the nano-catalysts.

15. The nano-catalysts synthesis method according to claim 10, wherein:
the electrode foil of the anode includes a platinum foil;
the inert gas includes Helium, Argon, or Neon; and
the microplasma outlet includes a capillary tube.

16. The nano-catalysts synthesis method according to claim 1, wherein: the purification step comprises neutralization, precipitation, filtration, drying and/or dialysis.

17. The nano-catalysts synthesis method according to claim 2, wherein: the purification step comprises neutralization, precipitation, filtration, drying and/or dialysis.

18. The nano-catalysts synthesis method according to claim 3, wherein: the purification step comprises neutralization, precipitation, filtration, drying and/or dialysis.

19. The nano-catalysts synthesis method according to claim 16, wherein:
the neutralization step includes neutralizing the solution obtained after the microplasma treatment with a small amount of an alkali; and
the precipitation step includes using a ketone for precipitation.
